(19) United States
(12) Patent Application Publication
(10) Pub. No.: US 2014/0067914 A1
(43) Pub. Date: Mar. 6, 2014

(54) COMPUTER SYSTEM AND PACKET TRANSFER METHOD

(71) Applicant: HITACHI, LTD., Tokyo (JP)

(72) Inventor: Koji NISHII, Fujisawa (JP)

(73) Assignee: Hitachi, Ltd., Tokyo (JP)

(21) Appl. No.: 13/785,064

(22) Filed: Mar. 5, 2013

(30) Foreign Application Priority Data
Aug. 31, 2012 (JP) 2012-191350

(51) Int. Cl. H04L 29/08

(52) U.S. Cl. CPC H04L 67/1008
USPC 709/203

(57) ABSTRACT

A computer system, comprising: a client computer; a server for providing the client computer with a service, a load balancer for transferring a packet transmitted from the client computer, a virtual machine that operates on the server, the virtual machine communicating another virtual machine by transmitting a packet including a virtual MAC address to be assigned to the virtual machine, virtual machine for providing a service being allocated to the client computer; and a management unit provided for each client computer, for monitoring a load of the virtual machine, and instructing one of addition and deletion of the virtual machine based on a monitoring result, the management unit being configured to: hold distribution information for distributing packets transmitted from the client computer; specify the server to which a new virtual machine is to be added, generate the virtual MAC address and the distribution information corresponding to the specified server.

### CLAIM OF PRIORITY

The present application claims priority from Japanese patent application JP 2012-191350 filed on Aug. 31, 2012, the content of which is hereby incorporated by reference into this application.

### BACKGROUND

This invention relates a computer system, and a method for packet distribution of a load balancer which is involved in addition and deletion of a virtual machine.

As implied by the rise of cloud type services, expansion of the client-server communication causes the traffic to rapidly increase year after year.

While the processing performances of servers themselves are improved, the improved performances cannot cope with the amount of traffic which needs to be processed. In this respect, a load distribution system is adopted to provide a load balancer between a client and a server to distribute traffic depending on the load of the server (see, for example, Japanese Patent Application Laid-open Nos. 2006-311470 and 2004-158977).

Japanese Patent Application Laid-open No. 2006-311470 describes: “a network including a plurality of servers with the same function and configuration and a server load balancer is coupled to a WAN or the Internet via routers, and the throughput of the network with such a configuration is determined by a high-layer processing apparatus which needs software processing, such as the server load balancer. Thus, in order to improve the throughput of the network in which the existing high-layer processing apparatus (server load balancer, firewall, or the like) is used, the high-layer processing apparatus is generally replaced with a processing apparatus with more enhanced capability.”

Japanese Patent Application Laid-open No. 2004-158977 describes: “a load distribution processing system which reduces mutual communications needed for load distribution within the system as much as possible and achieves the performance proportional to the number of load distribution apparatus is provided by achieving a network including a plurality of first load distribution apparatus that each analyze high-layer information included in a received packet to generate attribute information of the received packet, and send a packet added with the attribute information, a second load distribution apparatus that determines an optimal server to which individual packets are to be distributed based on traffic status information of the packet and the attribute information sent from the first load distribution apparatus, and sends the packets, and preferably a third load distribution apparatus that distributes the received packet to one of the plurality of first load distribution apparatus.”

According to the conventional load distribution systems, a client only needs to issue a processing request to a load balancer, which makes it unnecessary to be conscious of the configuration of the server. The hiding of the configuration of the server by the load balancer brings about such an effect that a modification of the configuration of the server by addition of a server or the like does not affect the client side.

A typical conventional load balancer executes the operation of NAT. When receiving a packet such as an Ethernet packet transmitted from a client, the load balancer extracts information indicating the relation between the packet and the server from the packet. Further, the load balancer rewrites an IP header and a MAC address header by referring to a connection table, and transmits the packets to the corresponding server.

Further, with the same procedure, when receiving a packet transmitted from the server, the load balancer extracts information indicating the relation between the packet and the client from the packet. Further, the load balancer rewrites an IP header and a MAC address header by referring to the connection table, and transmits the packets to the corresponding client.

When there is no corresponding entry in the connection table which has been referred to at the time of transferring a packet, the load balancer adds a new connection entry to the connection table in accordance with preset configuration information.

The configuration information includes, as client side information, terminal information and network information on the client side, such as the IP address and port number of the client, and includes, as server side information, network information on the server side and information on the server, such as the IP address and reception port number of the server, and a distribution/allocation rate depending on the processing performance of the server.

When client side information or server side information is changed, configuration information needs to be changed too. In a case of adding a server to cope with an increase in load, for example, the IP address and reception port number of the server, the distribution/allocation rate depending on the processing performance of the server, and the like are set again. At this time, the changed information is reflected by rebooting the load balancer, and hence the service needs to be interrupted.

As described above, the expansion/reduction of a server involves setting of the load balancer, and service interruption caused by reflection of the change, and hence a dynamic change in server configuration to flexibly cope with the traffic cannot be achieved.

Companies and individual persons can be provided with multifarious services, and at the same time, higher security is demanded. To cope with the demand, a virtualization technology of constructing a plurality of virtual machines on a single server is used on the server side. In recent years, enhancement of the hardware performances of servers and advancement of virtualization software have permitted a plurality of virtual machines to be constructed on a server.

The use of the virtualization technology can provide the base of securely providing each user with various services.

Virtual machines are provided on the server for the respective services of each client to execute value-added processes. The provision of virtual machines for each client service by service securely isolates client data.

In consideration of the foregoing background, the need to make good use of virtualization machines is likely to increase in future.

However, the increase in the number of virtual machines increases the management cost. Specifically, every time a virtual machine is added, it is necessary to set a network for transferring client data to the virtual machine. In addition, a dynamic change in network configuration which matches with the addition or deletion of a virtual machine to cope with the load in real time cannot be achieved.

In other words, while the technology capable of flexibly adding or deleting a virtual machine depending on the load is provided, there has not been provided any technology which permits the load balancer to cope with a dynamic change in the configuration of a server originating from addition or deletion of a virtual machine.

### SUMMARY

Japanese Patent Application Laid-open Nos. 2006-311470 and 2004-158977 describe technologies of avoiding the bottleneck of a load balancer in a network provided with the load balancer, but do not provide a technology of dynamically changing the setting of packet distribution of the load balancer when the server configuration is dynamically changed.

Further, addition of a virtual machine enlarges data of the connection table. The increase in data of the connection table increases the time for the load balancer to search for the transfer destination of a packet, which delays the transfer time. Accordingly, while the processing performance of the server is enhanced, the load balancer becomes the bottleneck of the overall system.

Accordingly, the technology described in Japanese Patent Application Laid-open No. 2004-158977 may be adopted. However, when a load balancer is added to overcome the bottleneck originating from the increase in load, the work of adding the load balancer is needed, and reflection of the setting for the load balancer inevitably interrupts the service. Therefore, a dynamic change in server configuration to flexibly cope with the traffic cannot be achieved.

This invention provides a load balancer technology which can cope with a change in server configuration spontaneously and flexibly in a computer system capable of flexibly adding or deleting a virtual machine depending on the load.

A representative aspect of the present disclosure is as follows. A computer system, comprising: a client computer; a server for providing the client computer with at least one service, the server comprising a first processor, a first memory connected to the first processor, and a first network interface connected to the first processor; a load balancer for transferring a packet transmitted from one of the client computer and the server, the load balancer comprising a second processor, a second memory connected to the second processor, and a second network interface connected to the second processor; at least one virtual machine that operates on the server, the at least one virtual machine communicating to/from another virtual machine by transmitting a packet including a virtual MAC address to be assigned to the at least one virtual machine, at least one virtual machine for providing a service being allocated to the client computer; and a management unit provided for each client computer, for monitoring a load of the at least one virtual machine, and instructing one of addition and deletion of the at least one virtual machine based on a monitoring result, the management unit being configured to: hold identification information on the client computer, identification information on the service to be provided to the client computer, and distribution information for distributing packets transmitted from the client computer; specify the server to which a new virtual machine is to be added, when it is determined based on the monitoring result that it is necessary to add a virtual machine which provides the client computer with the service; generate the virtual MAC address including the identification information on the client computer, the identification information on the service to be provided to the client computer, and the distribution information corresponding to the specified server; and transmit a command to generate the virtual machine including the generated virtual MAC address to the specified server.

According to the exemplary embodiment of this invention, when a virtual machine is added, a virtual MAC address including information needed to transfer a packet can be assigned to the added virtual machine. Therefore, the load balancer can automatically acquire necessary information from the virtual MAC address when receiving the packet, thus eliminating the need to make manually setting from an external device or stop the load balancer. Accordingly, the load balancer can cope with a change in server configuration spontaneously and flexibly.

### BRIEF DESCRIPTION OF THE DRAWINGS

FIG. 1 is a block diagram illustrating an example of a computer system according to an embodiment of this invention.

FIG. 2 is an explanatory diagram illustrating an example of the structure of the virtual MAC address according to the embodiment of this invention.

FIG. 3 is a block diagram illustrating an example of the hardware configuration and software configuration of the VM management computer according to the embodiment of this invention.

FIG. 4 is a block diagram illustrating an example of the hardware configuration and software configuration of the load balancer according to the embodiment of this invention.

FIG. 5 is an explanatory diagram illustrating an example of the processor load monitoring table according to the embodiment of this invention.

FIG. 6 is an explanatory diagram illustrating an example of the client management table according to the embodiment of this invention.

FIG. 7 is an explanatory diagram illustrating an example of the service type management table according to the embodiment of this invention.

FIG. 8 is an explanatory diagram illustrating an example of the physical server management table according to the embodiment of this invention.

FIG. 9 is an explanatory diagram illustrating an example of the VM management table according to the embodiment of this invention.

FIG. 10 is an explanatory diagram illustrating an example of the distribution management table according to the embodiment of this invention.

FIG. 11 is a flowchart illustrating the details of processing which are executed by the VM management computer in the embodiment of this invention.

FIG. 12 is an explanatory diagram illustrating the outline of the processing according to the embodiment of this invention.

FIG. 13 is an explanatory diagram illustrating an example of the virtual MAC address which is assigned to a new VM according to the embodiment of this invention.

FIG. 14 is an explanatory diagram illustrating an example of a notification method for the virtual MAC address 123 according to the embodiment of this invention.

FIG. 15 is an explanatory diagram illustrating an example of the MAC table according to the embodiment of this invention.

FIG. 16 is an explanatory diagram illustrating an example of the Ethernet packet in service network according to the embodiment of this invention.

FIGS. 17A and 17B are flowcharts illustrating details of processing executed by the load balancer according to the embodiment of this invention.

### DETAILED DESCRIPTION OF THE PREFERRED EMBODIMENT

Now, an embodiment of this invention is described referring to the accompanying drawings. The same reference numerals represent the same components or equivalent components through the drawings. For the sake of descriptive convenience, suffixes may be added to distinguish the same components or equivalent components from one another.

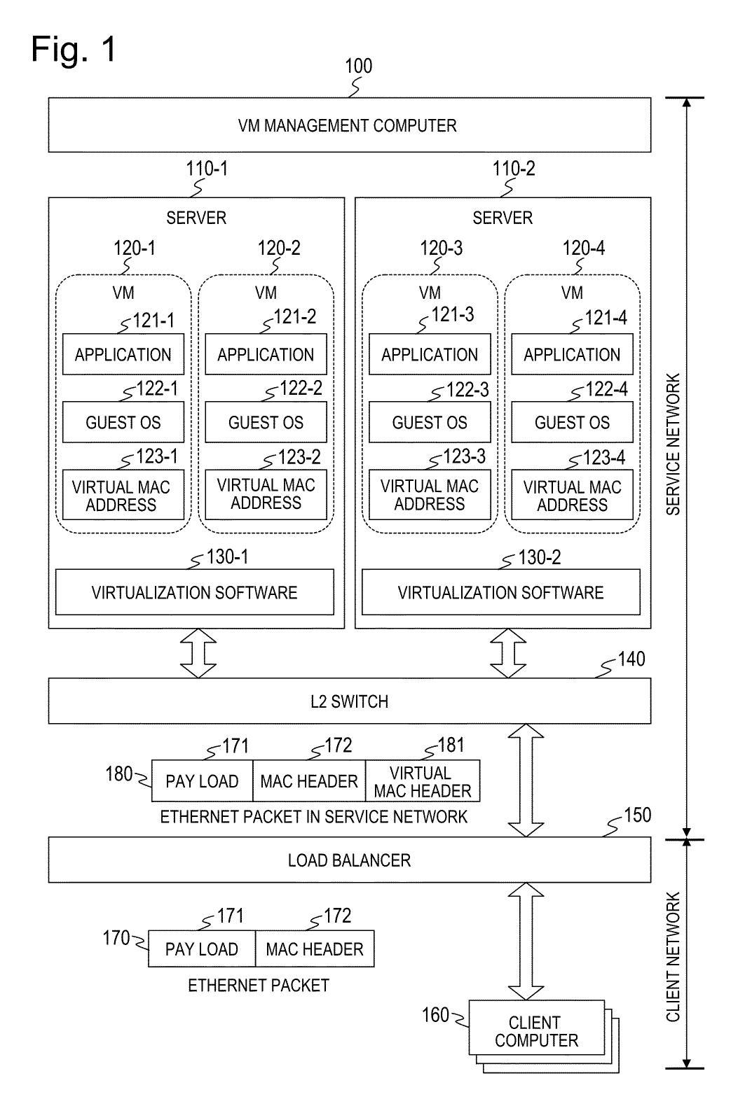

FIG. 1 is a block diagram illustrating an example of a computer system according to the embodiment of this invention.

The computer system according to this embodiment includes a VM management computer 100, a server 110-1, a server 110-2, an L2 switch 140, a load balancer 150, and a plurality of client computers 160.

The VM management computer 100, the server 110-1, the server 110-2, the L2 switch 140, the load balancer 150, and the plurality of client computers 160 are coupled to one another over a predetermined network. This invention is not limited by the type of a network, and may adopt any one of a WAN, LAN, and SAN. In addition, the coupling method may be any one of wireless coupling and cable coupling.

The VM management computer 100 manages a virtual computer or virtual machine (hereinafter referred to as “VM”) which operates on the server 110-1 and the server 110-2. The hardware configuration and software configuration of the VM management computer 100 are described later referring to FIG. 3.

The server 110-1 is a computer on which a VM 120 operates. The server 110-1 includes a processor (not shown), a memory (not shown), a storage medium (not shown), and a network interface (not shown).

The server 110-1 executes virtualization software 130-1 that manages VMs 120, which permit a plurality of VMs 120 to operate on a single server. In the example illustrated in FIG. 1, a VM 120-1 and a VM 120-2 operate on the server 110-1.

The virtualization software 130-1 logically divides the physical resource the server 110-1 has, to thereby allocate a virtual processor, a virtual memory, a virtual storage medium, and a virtual network interface to a VM 120.

In the VM 120-1, a guest OS 122-1 is operating, and an application 121-1 is executed on the guest OS 122-1. A virtual MAC address 123-1 is assigned to the VM 120-1. The application 121-1 processes a packet transmitted from a client computer 160 to provide a predetermined service.

In the VM 120-2, a guest OS 122-2 is operating, and an application 121-2 is executed on the guest OS 122-2. A virtual MAC address 123-2 is assigned to the VM 120-2.

The VM 120-1 and the VM 120-2 communicate with each other using the virtual MAC address 123-1 and the virtual MAC address 123-2. According to this invention, the VM management computer 100 assigns the virtual MAC addresses.

The server 110-2 is also a computer on which the VM 120 operates. The server 110-1 includes a processor (not shown), a memory (not shown), a storage medium (not shown), and a network interface (not shown).

The server 110-2 executes virtualization software 130-2 so that a VM 120-3 and a VM 120-4 operate. The description on the configuration of the server 110-2, which is identical to that of the server 110-1, is omitted.

Each of the server 110-1 and the server 110-2 is hereinafter referred to as “server 110” when both servers are not distinguished from each other. Further, each of the VM 120-1, the VM 120-2, the VM 120-3, and the VM 120-4 is hereinafter referred to as “VM 120” when those VMs are not distinguished from one another, and each of the virtualization software 130-1 and the virtualization software 130-2 is hereinafter referred to as “virtualization software 130” when both pieces of virtualization software are not distinguished from each other. Likewise, each of the application 121-1, the application 121-2, the application 121-3, and the application 121-4 is hereinafter referred to as “application 121” when those applications are not distinguished from one another, each of the guest OS 122-1, the guest OS 122-2, the guest OS 122-3, and the guest OS 122-4 is hereinafter referred to as “guest OS 122” when those guest OSs are not distinguished from one another, and each of the virtual MAC address 123-1, the virtual MAC address 123-2, the virtual MAC address 123-3, and the virtual MAC address 123-4 is hereinafter referred to as “virtual MAC address 123” when those virtual MAC addresses are not distinguished from one another.

The client computer 160 is a computer that transmits a processing packet to a server 110. The client computer 160 includes a processor (not shown), a memory (not shown), a storage medium (not shown), and a network interface (not shown).

According to this embodiment, at least one VM 120 is allocated to a single service for a client (user) who manipulates the client computer 160. In other words, one operational system is provided for each client and for each service. The client computer 160 can be provided with a predetermined service by transmitting a processing packet to the operational system.

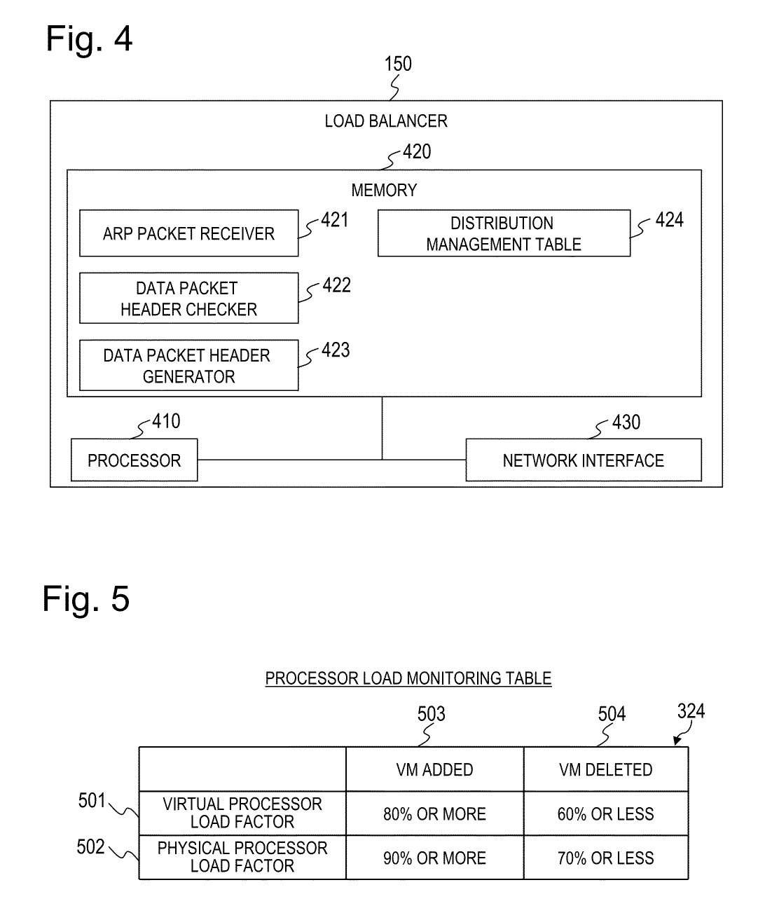

The load balancer 150 distributes packets transmitted from the client computers 160 to adequate servers 110. The hardware configuration and software configuration of the load balancer 150 are described later referring to FIG. 4.

The L2 switch 140 transfers a packet transmitted from the load balancer 150 to a server 110, and transfers a packet transmitted from a server 110 to another server 110 or the load balancer 150. As described later, the L2 switch 140 transfers a packet to a predetermined server 110 in accordance with the virtual MAC header added by the load balancer 150.

According to this embodiment, the network that couples the VM management computer 100, the servers 110, the L2 switch 140, and the load balancer 150 to one another is referred to as “service network”, and the network that couples the load balancer 150 and the client computers 160 to one another is referred to as “client network”.

Communication is carried out within the client network by using an Ethernet packet 170, whereas communication is carried out within the service network by using an Ethernet packet in service network 180.

The Ethernet packet 170 includes two fields of a pay load 171 and a MAC header 172. The Ethernet packet in service network 180 includes three fields of a pay load 171, a MAC header 172, and a virtual MAC header 181.

Now, the virtual MAC address 123 that is assigned to the VM 120 is described.

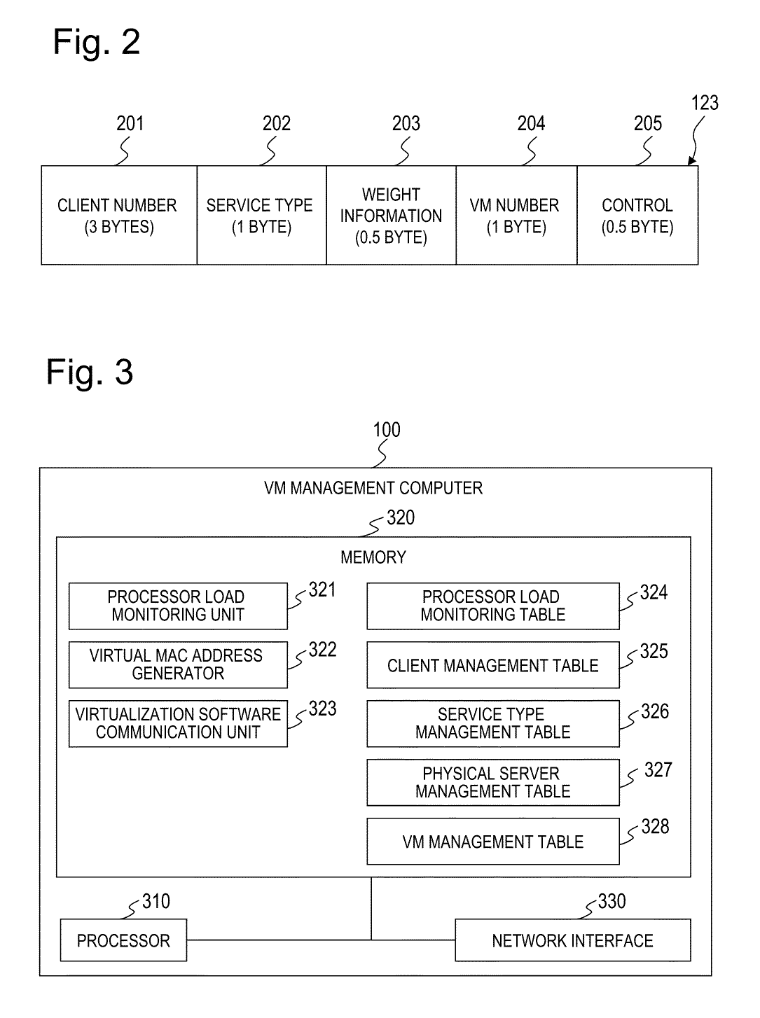

FIG. 2 is an explanatory diagram illustrating an example of the structure of the virtual MAC address 123 according to the embodiment of this invention.

The virtual MAC address 123 is a 6-byte identifier for identifying a VM 120 on a virtual network, and includes five fields of a 3-byte client number field 201, a 1-byte service type field 202, a 0.5-byte weight information field 203, a 1-byte VM number field 204, and a 0.5-byte control field 205.

The client number field 201 includes three identifiers to uniquely identify a client computer 160. The service type field 202 includes information for identifying the type of a service that the client computer 160 is providing by using the VM 120. The weight information field 203 includes a weighting factor which is used to distribute a packet.

The VM number field 204 includes the number of VMs 120 to be allocated to a predetermined service for a predetermined client. The control field 205 includes a control type for the load balancer 150.

The conventional MAC address includes 3-byte information indicating a manufacturer for a network interface card and 3-byte information which is a unique number in the manufacturer. Therefore, the conventional MAC address is used only as an identifier for an information terminal in the Ethernet, and does not have other additional information.

Conventionally, the virtual MAC address 123 only needs to be able to uniquely identify each VM 120 in the service network, and hence the virtual MAC address 123 is assigned to each VM at random. However, this invention has a feature in that the virtual MAC address 123 including the client number field 201 and the service type field 202 is assigned to be used in the distribution process of the load balancer 150 for a processing packet which is transmitted from a client computer 160.

FIG. 3 is a block diagram illustrating an example of the hardware configuration and software configuration of the VM management computer 100 according to the embodiment of this invention.

The VM management computer 100 includes a processor 310, a memory 320, and a network interface 330.

The processor 310 runs a program to be stored in the memory 320. The execution of the program by the processor 310 achieves the functions of the VM management computer 100. When a program is a subject in a sentence in the following description, it represents that the program is run by the processor 310.

The network interface 330 is an interface that serves to communicate to/from other devices over a network, and may be, for example, an NIC or the like.

The memory 320 stores a program which is run by the processor 310, and information necessary to run the program.

According to this embodiment, the memory 320 stores programs that achieve a processor load monitoring unit 321, a virtual MAC address generator 322, and a virtualization software communication unit 323. Further, the memory 320 stores, as information, a processor load monitoring table 324, a client management table 325, a service type management table 326, a physical server management table 327, and a VM management table 328.

The processor load monitoring unit 321 monitors a load on the processor provided in a server 110 and a load on the virtual processor which is allocated to a VM 120. The virtual MAC address generator 322 generates a virtual MAC address 123 to be assigned to the VM 120. The virtualization software communication unit 323 communicates to/from the virtualization software 130.

The processor load monitoring table 324 stores the result of monitoring the load on the processor provided in the server 110 and the result of monitoring the load on the virtual processor which is allocated to the VM 120. The details of the processor load monitoring table 324 are described later referring to FIG. 5.

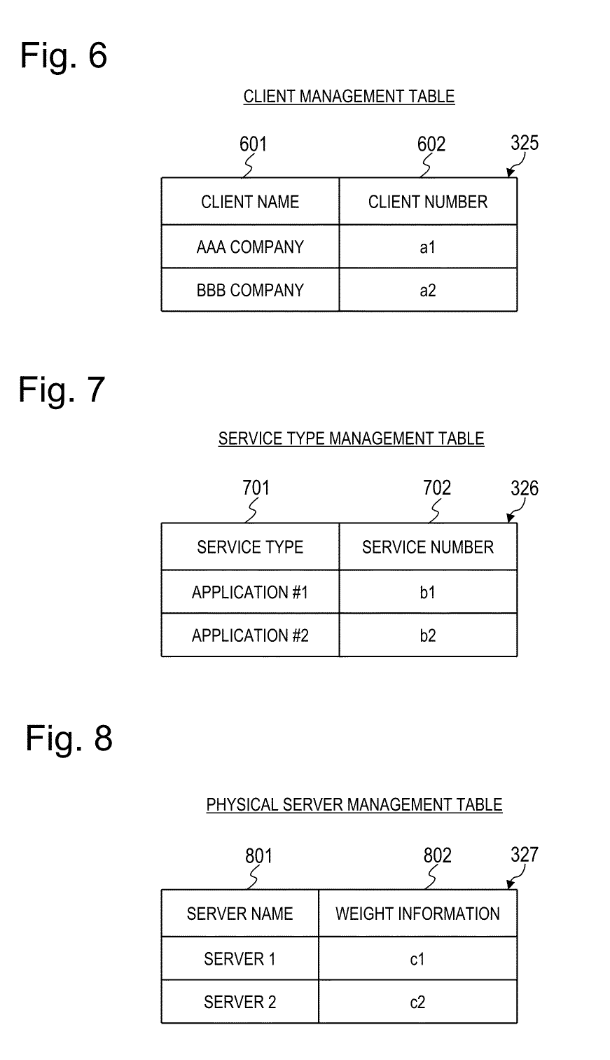

The client management table 325 stores management information on a client computer 160. The details of the client management table 325 are described later referring to FIG. 6. The service type management table 326 stores information on the type of a service which is carried out by using a VM 120. The details of the service type management table 326 are described later referring to FIG. 7.

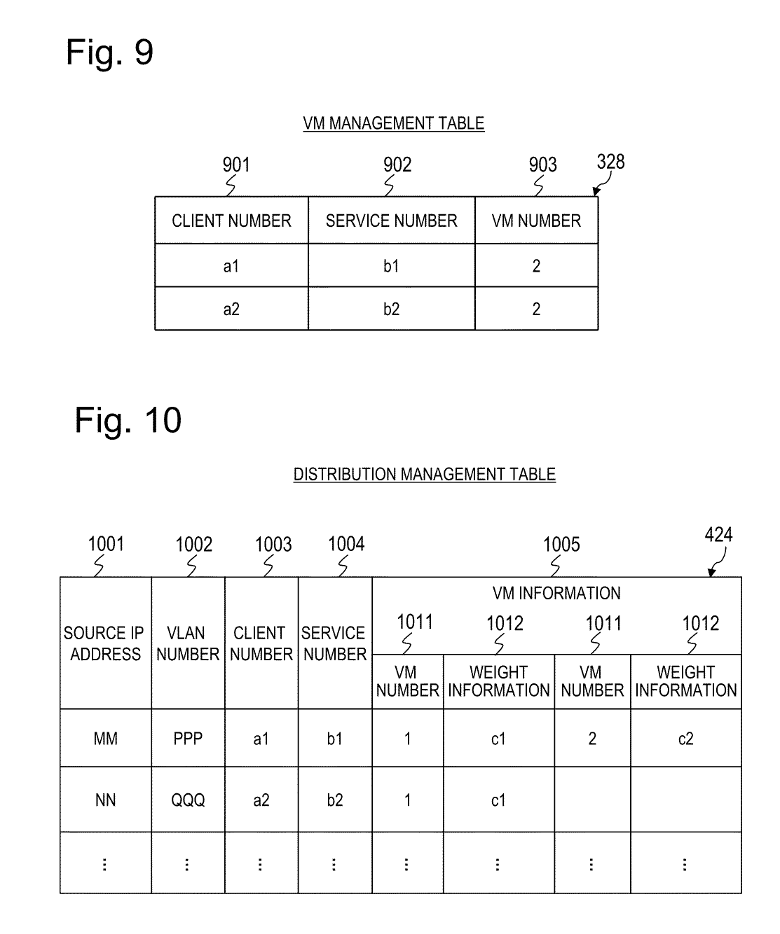

The physical server management table 327 stores information which associates a server 110 with weight information representing the transfer ratio of a processing packet for the server 110. The details of the physical server management table 327 are described later referring to FIG. 8. The VM management table 328 stores management information on a VM 120. The details of the VM management table 328 are described later referring to FIG. 9.

FIG. 4 is a block diagram illustrating an example of the hardware configuration and software configuration of the load balancer 150 according to the embodiment of this invention.

The load balancer 150 includes a processor 410, a memory 420, and a network interface 430.

The processor 410 runs a program to be stored in the memory 420. The execution of the program by the processor 410 achieves the functions of the load balancer 150. When a program is a subject in a sentence in the following description, it represents that the program is run by the processor 410.

The network interface 430 is an interface that serves to communicate to/from other devices over a network, and may be, for example, an NIC or the like.

The memory 420 stores a program which is run by the processor 410, and information necessary to run the program.

According to this embodiment, the memory 420 stores programs that achieve an ARP packet receiver 421, a data packet header checker 422, and a data packet header generator 423. Further, the memory 420 stores, as information, a distribution management table 424.

The ARP packet receiver 421 receives an ARP packet. The data packet header checker 422 checks the header of the received packet. The data packet header generator 423 generates a packet header.

The distribution management table 424 stores information which is used to transfer the received packet. The details of the distribution management table 424 are described later referring to FIG. 10.

It should be noted that the memory 420 also stores an old transfer history (not shown).

FIG. 5 is an explanatory diagram illustrating an example of the processor load monitoring table 324 according to the embodiment of this invention.

The processor load monitoring table 324 is a matrix type of information having a virtual processor load factor 501 and a physical processor load factor 502 in rows and a VM addition 503 and a VM deletion 504 in columns.

The VM addition 503 indicates a case where a VM 120 needs to be added, and the VM deletion 504 indicates a case where a VM 120 needs to be deleted. The virtual processor load factor 501 indicates the load factor of a virtual processor which is allocated to a VM 120, and the physical processor load factor 502 indicates the load factor of a processor provided in a server 110.

When the result of monitoring the processor load shows that the load factor of the virtual processor is 85%, for example, this case corresponds to the VM addition 503 by referring to the entry of the virtual processor load factor 501, and hence a VM 120 is added.

A case where a VM 120 needs to be added is hereinafter referred to as an event of adding a VM 120, and a case where a VM 120 needs to be deleted is hereinafter referred to as an event of deleting a VM 120.

FIG. 6 is an explanatory diagram illustrating an example of the client management table 325 according to the embodiment of this invention. FIG. 7 is an explanatory diagram illustrating an example of the service type management table 326 according to the embodiment of this invention. FIG. 8 is an explanatory diagram illustrating an example of the physical server management table 327 according to the embodiment of this invention.

The client management table 325 includes a client name 601 and a client number 602. The client name 601 stores an identification name for identifying a client (user) who manipulates the client computer 160. The client number 602 stores an identification number for uniquely identifying a client (user) who manipulates the client computer 160.

The service type management table 326 includes a service type 701 and a service number 702. The service type 701 stores information for identifying a service to be provided. For example, the service type 701 stores the identification number, name, or the like of an application 121. The service number 702 stores an identification number for identifying a service to be provided by using the application 121.

The client management table 325 and the service type management table 326 are information to be set by an operator of a service network at the time of making a contract with a client.

The physical server management table 327 includes a server name 801 and weight information 802. The server name 801 stores information for identifying a server 110. For example, the information may be a server name or an identification number set for a server 110. The weight information 802 stores a weighting factor which is used when a packet is distributed.

The weighting factor is a value that is used when calculating the distribution ratio of packets for a plurality of VMs 120 which provide a service of the same service type for the same client. It should be noted that a service sets a weighting factor based on parameters such as the processing performance of a server 110.

FIG. 9 is an explanatory diagram illustrating an example of the VM management table 328 according to the embodiment of this invention.

The VM management table 328 includes a client number 901, a service number 902, and a VM number 903.

The client number 901 and the service number 902 are identical to the client number 602 and the service number 702, respectively. The VM number 903 stores the number of VMs 120 which provides a client corresponding to the client number 901 with a service corresponding to the service number 902.

According to this embodiment, one entry is generated for the combination of the client number 901 and the service number 902.

When a VM 120 which provides a predetermined client with a service is newly added, a value obtained by incrementing the current value by “1” is stored in the VM number 903 of the corresponding entry. When a VM 120 which provides a predetermined client with a service is deleted, a value obtained by decrementing the current value by “1” is stored in the VM number 903 of the corresponding entry.

In the example illustrated in FIG. 9, two VMs 120 which provide a service with the service number 902 of “b1” are allocated to a client with the client number 901 of “a1”.

FIG. 10 is an explanatory diagram illustrating an example of the distribution management table 424 according to the embodiment of this invention.

The distribution management table 424 includes a source IP address 1001, a VLAN number 1002, a client number 1003, a service number 1004, and VM information 1005.

The source IP address 1001 stores an IP address set in the header of a packet transmitted from a client network. The VLAN number 1002 stores the identification number of a VLAN set in the header of a packet transmitted from the client network.

Information to be stored in each of the source IP address 1001 and the VLAN number 1002 is the information that is set by the operator of the service network at the time of making a service contract with the client. The source IP address 1001 and the VLAN number 1002 are identification information on the client network.

The client number 1003 is the identification number of the client corresponding to the source IP address 1001 and the VLAN number 1002, and is identical to the client number 602. The service number 1004 is the identification number of the service that is provided to the client corresponding to the source IP address 1001 and the VLAN number 1002, and is identical to the service number 702.

Information to be stored in each of the client number 1003 and the service number 1004 is the information that is set by the operator of the service network at the time of making a service contract with the client. The client number 1003 and the service number 1004 are management information in the service network.

The VM information 1005 stores information on a VM 120 to which a packet corresponding to the source IP address 1001, the VLAN number 1002, the client number 1003, and the service number 1004 is transmitted. The VM information 1005 includes column information including a VM number 1011 and weight information 1012 for each VM 120. In other words, when a VM 120 is added, new column information is added to the VM information 1005, and when a VM 120 is deleted, corresponding column information is deleted from the VM information 1005.

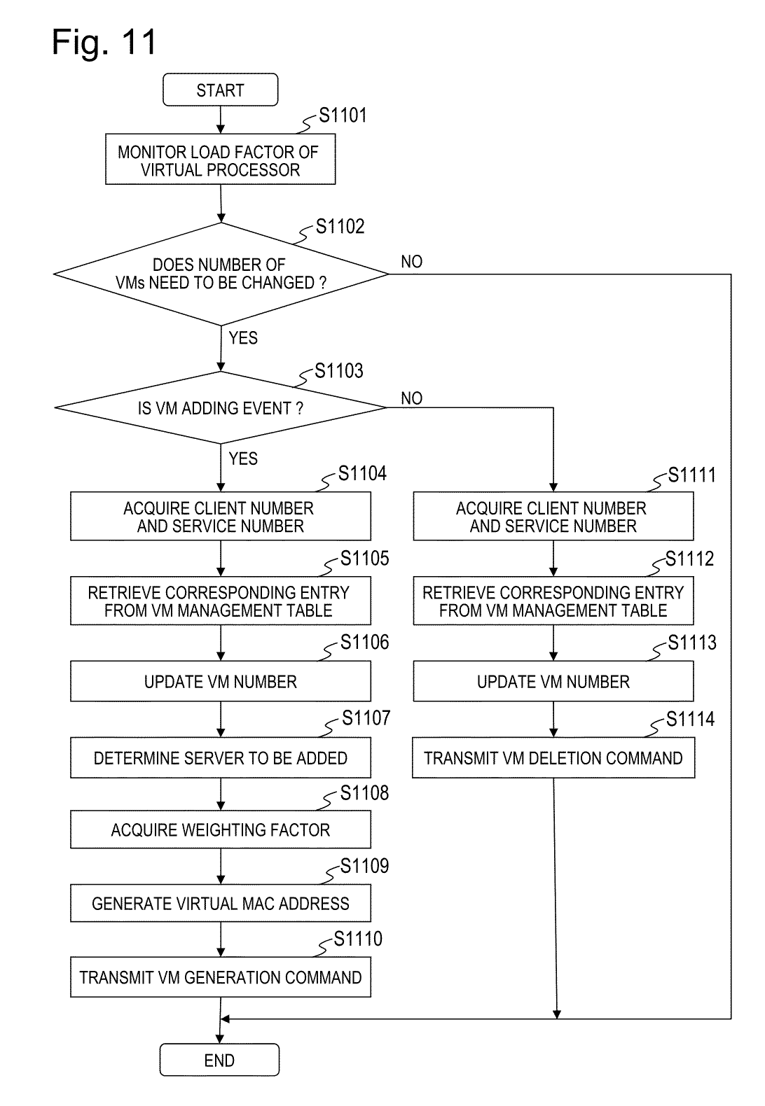

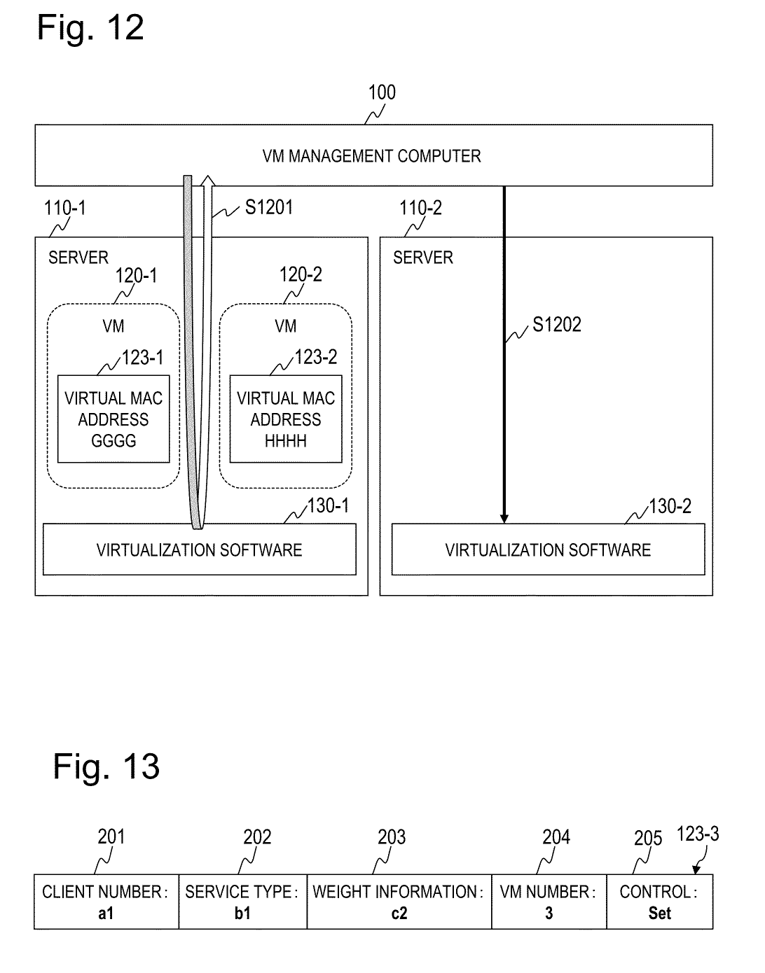

FIG. 11 is a flowchart illustrating the details of processing which are executed by the VM management computer 100 in the embodiment of this invention. FIG. 12 is an explanatory diagram illustrating the outline of the processing according to the embodiment of this invention. FIG. 13 is an explanatory diagram illustrating an example of the virtual MAC address 123 which is assigned to a new VM 120 according to the embodiment of this invention.

The VM management computer 100 cyclically executes the processing to be described below. The VM management computer 100 also executes the processing to be described below client by client.

The following description of the embodiment is given of a case where processing request packets to be transmitted from a client computer 160 with the client name 601 of “AAA company” increase. It is assumed that as illustrated in FIG. 12, the VM 120-1 and the VM 120-2 in the server 110-1 are allocated as VMs 120 which provide the client with services.

First, the VM management computer 100 monitors the load factors of the virtual processors of the VM 120-1 and the VM 120-2 (Step S1101).

Specifically, as illustrated in FIG. 12, the VM management computer 100 acquires the load factors of the virtual processors of the VM 120-1 and the VM 120-2 from the virtualization software 130-1 of the server 110-1 (Step S1201). At this time, the VM management computer 100 also acquires the load factor of the processor of the server 110-1 itself. It should be noted that the method of monitoring the load factors of the virtual processors of the VM 120-1 and the VM 120-2 is not limited to the above-mentioned method.

Based on the acquired load factors of the virtual processors, the VM management computer 100 determines whether or not the number of VMs 120 to be allocated to the client needs to be changed (Step S1102).

Specifically, referring to the processor load monitoring table 324, the VM management computer 100 determines whether or not at least one of the load factor of the virtual processor allocated to the VM 120-1, the load factor of the virtual processor allocated to the VM 120-2, and the load factor of the processor of the server 110 itself matches a condition.

According to this embodiment, it is assumed that the load factor of the virtual processor of the VM 120-1 is 80% or more. In this case, a VM 120 needs to be added, and hence the VM management computer 100 determines that it is necessary to change the number of VMs 120 to be allocated to the client.

When it is determined that it is necessary to change the number of VMs 120 to be allocated to the client, the VM management computer 100 determines whether or not an event is to add a VM 120 based on the result of the determination in Step S1102 (Step S1103).

When it is determined that the event is to add a VM 120, the VM management computer 100 executes processing of generating a virtual MAC address 123 to be assigned to a VM 120 to be newly added (Steps S1104 to S1108). At this time, the VM management computer 100 inquires the virtualization software 130-1 to acquire identification information on the application 121-1 to be executed on the VM 120-1.

First, the VM management computer 100 acquires the client number 602 of a client to whom the VM 120 is to be added and the service number 702 corresponding to the client from the client management table 325 and the service type management table 326 (Step S1104). Specifically, the following processing is executed.

Referring to the client name 601 in the client management table 325, the VM management computer 100 retrieves an entry which matches with the client name of the client for whom the processing is to be executed. The VM management computer 100 acquires the client number 602 from the retrieved entry.

Further, referring to the service type 701 in the service type management table 326, the VM management computer 100 retrieves an entry which matches with identification information on the application 121-1 to be executed on the VM 120-1. The VM management computer 100 acquires the service number 702 from the retrieved entry.

According to this embodiment, “a1” is acquired as the client number 602 and “b1” is acquired as the service number 702.

The foregoing is the processing of Step S1104.

Next, based on the acquired client number 602 and service number 702, the VM management computer 100 retrieves a corresponding entry by referring to the VM management table 328 (Step S1105).

According to this embodiment, the VM management computer 100 retrieves an entry with the client number 901 of “a1” and the service number 902 of “b1”. Referring to the VM number 903 of the retrieved entry, the VM management computer 100 can grasp the number of VMs 120 which provide a client with a service.

In the example illustrated in FIG. 9, it is apparent that two VMs 120 which provide a client with a service are allocated.

The VM management computer 100 updates the VM number 903 of the retrieved entry (Step S1106).

Specifically, the VM management computer 100 stores a value obtained by incrementing the value of the VM number 903 of the retrieved entry by “1”. According to this embodiment, the VM number 903 is updated from “2” to “3”.

The VM management computer 100 determines a server 110 which generates a new VM 120 (Step S1107).

Because a known technology may be adopted as the method of determining a server 110 which generates a new VM 120, its description is omitted. Examples of available methods include a method of selecting a server 110 which has the largest number of allocatable physical resources and a method of selecting a server 110 which has the lowest load of the processor or the like. It should be noted that this invention is not limited by the method of determining a server 110 which generates a new VM 120.

According to this embodiment, it is assumed that a new VM 120-3 is generated in a server 110-2. It is also assumed that the VM 120-3 is a copy of the VM 120-2 or the VM 120-3.

The VM management computer 100 acquires, from the physical server management table 327, the weighting factor of the server 110-2 that generates the new VM 120 (Step S1108).

Specifically, referring to the physical server management table 327, the VM management computer 100 retrieves an entry whose server name 801 matches with the identification name of the server 110-2. The VM management computer 100 acquires a weighting factor from weight information 802 in the retrieved entry. According to this embodiment, “c2” is acquired as the weighting factor.

Based on the information acquired from the individual tables, the VM management computer 100 generates a virtual MAC address 123-3 to be assigned to the new VM 120 (Step S1109).

Specifically, as illustrated in FIG. 13, the VM management computer 100 generates the virtual MAC address 123-3 in which “a 1” is included in the client number field 201, “b1” is included in the service type field 202, “c2” is included in the weight information field 203, “3” is included in the VM number field 204, and a control code “Set” is included in the control field 205.

The control code “Set” is a control code that represents that the virtual MAC address 123 is valid, and allows the load balancer 150 to execute transfer processing using the virtual MAC address 123.

The VM management computer 100 transmits a VM generation command including the generated virtual MAC address 123-3 to the virtualization software 130-2 (Steps S1110 and S1202), and then ends the processing.

The virtualization software 130-2 generates the VM 120-3 in response to the received VM generation command. At this time, the generated virtual MAC address 123-3 is assigned to the VM 120-3. The virtual MAC address 123-3 with “Set” set in the control field 205 is used until the VM 120 is deleted.

When it is determined in Step S1103 that the event is not to add a VM 120, in other words, when it is determined that the event is to delete a VM 120, the VM management computer 100 acquires the client number 602 of a client for whom the VM 120 is to be deleted, and the service number 702 corresponding to the client from the client management table 325 and the service type management table 326 (Step S1111). The processing in Step S1111 is the same as that of Step S1104.

Based on the acquired client number 602 and service number 702, the VM management computer 100 retrieves a corresponding entry by referring to the VM management table 328 (Step S1112). The processing in Step S1112 is the same as that of Step S1105.

The VM management computer 100 updates the VM number 903 of the retrieved entry (Step S1113).

Specifically, the VM management computer 100 stores a value obtained by decrementing the value of the VM number 903 of the retrieved entry by “1”.

The VM management computer 100 transmits a command to delete a VM 120 to the virtualization software 130 (Step S1114), and then ends the processing.

When the VM 120-2 is to be deleted, for example, the VM management computer 100 transmits a command to delete the VM 120-2 to the virtualization software 130-1. At this time, the virtualization software 130-1 transmits a shutdown command to the VM 120-2. When receiving the shutdown command, the VM 120-2 transmits a gratuitous ARP packet having a control code “Del” stored in the control field 205 of a virtual MAC address 123-2 assigned to the VM 120-2. After the shutdown processing is terminated, the VM 120-2 is deleted from the server 110-1.

The control code “Del” is a control code that represents that the virtual MAC address 123 is invalid, and instructs the load balancer 150 to delete information on the virtual MAC address 123.

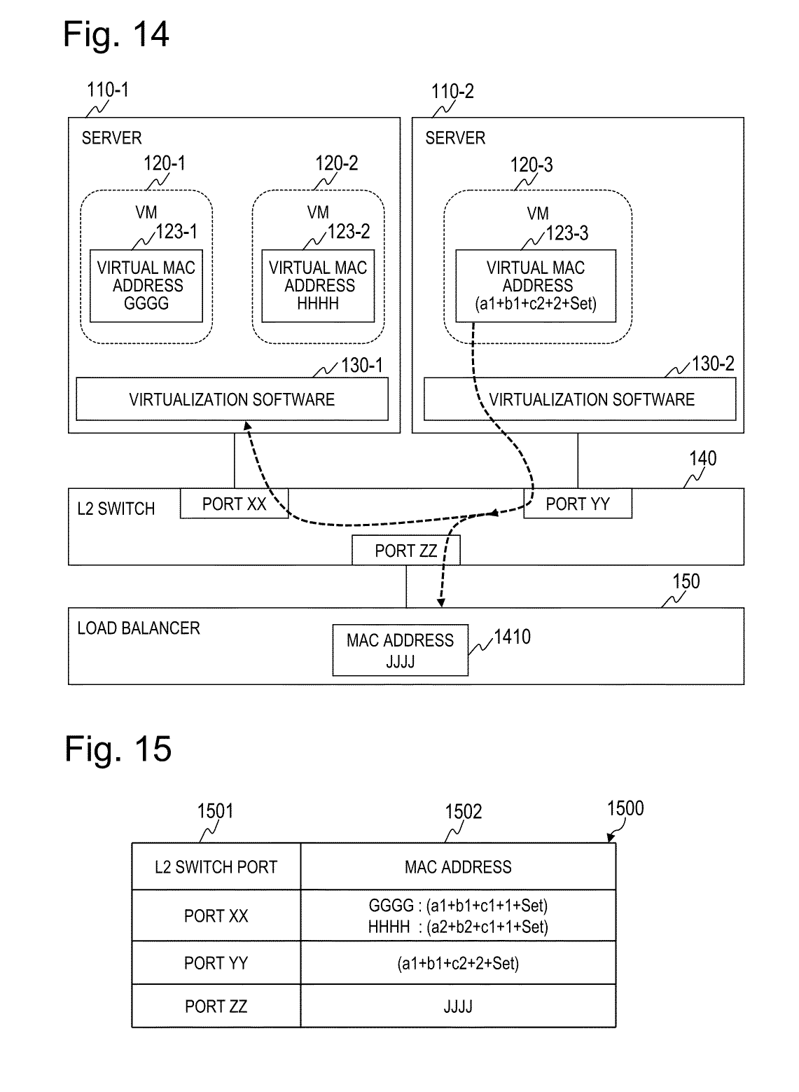

FIG. 14 is an explanatory diagram illustrating an example of a notification method for the virtual MAC address 123 according to the embodiment of this invention.

In this embodiment, the gratuitous ARP packet is used to notify of the virtual MAC address 123 assigned to the VM 120.

The newly-generated VM 120-3 uses the assigned virtual MAC address 123-3 after being activated to generate the gratuitous ARP packet, and transmits the generated gratuitous ARP packet.

The gratuitous ARP packet is a broadcast packet, and is used for notifying the L2 switch 140 and the load balancer 150 of the MAC address of the machine itself (in this case, the virtual MAC address 123-3 of the VM 120-3).

The L2 switch 140 receives from a “port YY” the gratuitous ARP packet transmitted from the VM 120-3, and transmits the packet from a “port XX” and a “port ZZ”.

The load balancer 150 receives the gratuitous ARP packet via the “port ZZ” of the L2 switch 140. Further, the server 110-1 receives the gratuitous ARP packet via the “port XX”.

As described above, the load balancer 150 can acquire the virtual MAC address of the newly-generated VM 120 based on the gratuitous ARP packet received via the L2 switch 140.

Further, when the VM 120-3 transmits a packet to the client computer 160 whose client name is the “AAA company”, the guest OS 122-3 of the VM 120-3 encapsulates the packet with an Ethernet packet in service network 180, and transmits the encapsulated packet to the L2 switch 140. A MAC address 1410 of the load balancer 150 is used as the destination MAC address of the Ethernet packet in service network 180, and the virtual MAC address 123-3 of the VM 120-3 is used as the transmission source MAC address of the Ethernet packet in service network 180.

Further, when the VM 120-3 transmits a packet to the client computer 160 whose client name is the “AAA company”, the guest OS 122-3 of the VM 120-3 generates an Ethernet packet in the service network, and transmits the generated packet to the L2 switch 140. A MAC address 1410 of the load balancer 150 is used as the destination MAC address of the Ethernet packet in the service network, and the virtual MAC address 123-3 of the VM 120-3 is used as the transmission source MAC address of the Ethernet packet in the service network.

When receiving the above-mentioned packet, the L2 switch 140 transmits the packet from the port ZZ. The packet transmitted from the port ZZ of the L2 switch 140 is received by the load balancer 150.

It should be noted that the L2 switch 140 transfers the received packet by using a MAC table 1500 such as the one illustrated in FIG. 15.

FIG. 15 is an explanatory diagram illustrating an example of the MAC table 1500 according to the embodiment of this invention. FIG. 15 illustrates the MAC table 1500 after the gratuitous ARP packet transmitted from the VM 120-3 is transferred.

The MAC table 1500 includes columns of an L2 switch port 1501 and a MAC address 1502. The L2 switch port 1501 stores identification information on the port the L2 switch 140 is provided with. The MAC address 1502 stores the MAC address of the device coupled via the port of the L2 switch 140.

For example, when receiving the packet to be transferred to the virtual MAC address 123-3 assigned to the VM 120-3, the L2 switch 140 refers to the MAC table 1500 to transfer the packet to the server 110-2 from the “port YY”. In this manner, the VM 120-3 can receive the packet.

It should be noted that as illustrated in FIG. 15, the virtual MAC address 123 assigned to each of the VM 120-1 and the VM 120-2 also has a structure such as the one illustrated in FIG. 13.

Further, when the VM 120 is to be deleted, in the MAC table 1500, as the virtual MAC address 123 of the VM 120 to be deleted, the virtual MAC address 123 whose control field 205 is “Set” and the virtual MAC address 123 whose control field 205 is “Del” are stored. In this case, the L2 switch 140 automatically deletes the relevant entry from the MAC table 1500 after a predetermined period of time.

Next, the Ethernet packet in service network 180 is described.

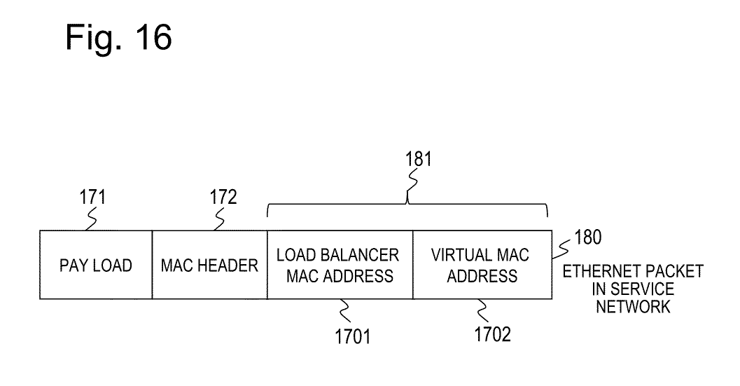

FIG. 16 is an explanatory diagram illustrating an example of the Ethernet packet in service network 180 according to the embodiment of this invention.

The Ethernet packet in service network 180 includes the pay load 171, the MAC header 172, and the virtual MAC header 181.

The pay load 171 is a field in which specific data is stored. The MAC header 172 is a field in which the MAC address of the client computer 160 in the client network is stored.

The virtual MAC header 181 is header information used in the service network, and includes a load balancer MAC address 1701 and a virtual MAC address 1702. As described later, the virtual MAC header 181 is added and deleted by the load balancer 150.

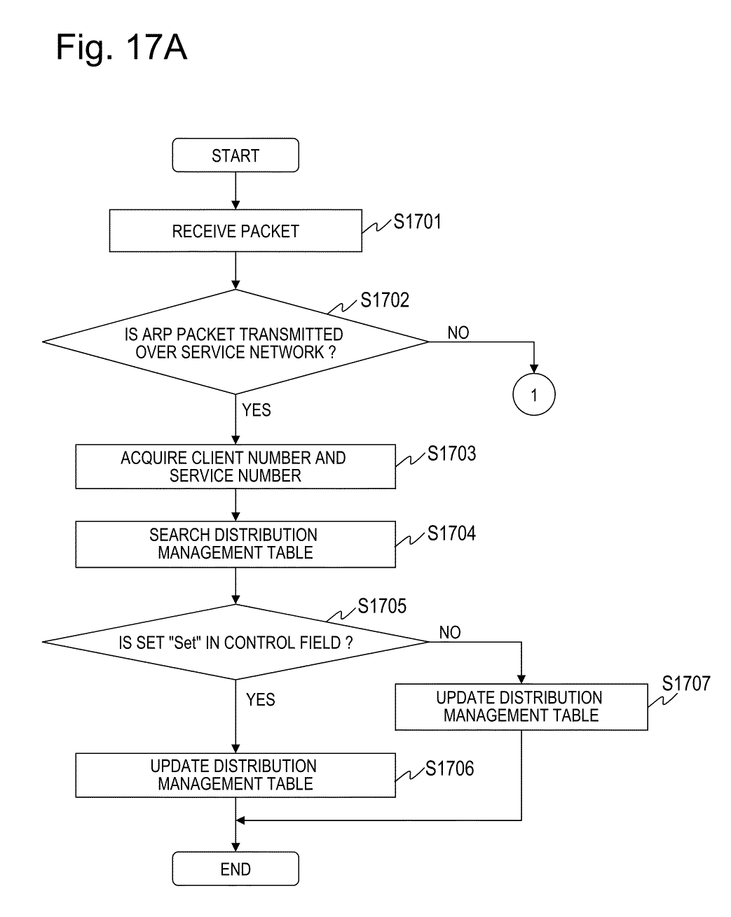

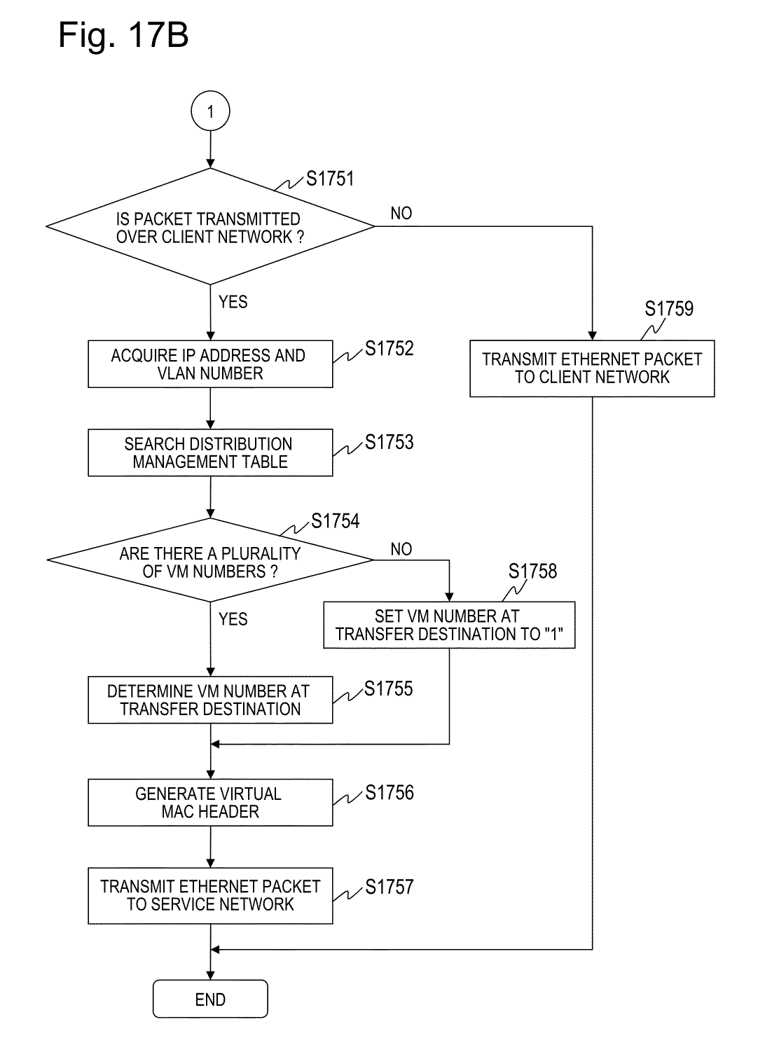

FIGS. 17A and 17B are flowcharts illustrating details of processing executed by the load balancer 150 according to the embodiment of this invention.

When receiving the packet (Step S1701), the load balancer 150 determines whether or not the received packet is an ARP packet transmitted over the service network (Step S1702). Specifically, the following processing is executed.

The load balancer 150 determines whether or not the virtual MAC header 181 is added to the received packet. When the virtual MAC header 181 is added to the received packet, the load balancer 150 further refers to the MAC header 172 of the received packet to determine whether or not a control code of the ARP protocol is included therein.

When the control code of the ARP protocol is included in the MAC header 172 of the received packet, the load balancer 150 determines that the received packet is the ARP packet transmitted over the service network.

When it is determined that the received Ethernet packet is the ARP packet transmitted over the service network, the load balancer 150 acquires the client number and the service number from the ARP packet (Step S1703).

Specifically, the load balancer 150 acquires values of the client number field 201 and the service type field 202 from the virtual MAC address 1702 of the virtual MAC header 181.

The load balancer 150 refers to the distribution management table 424 to search for an entry having values matching the values of the client number field 201 and the service type field 202 (Step S1704).

Specifically, the load balancer 150 searches for an entry whose client number 1003 and service number 1004 matches the acquired values of the client number field 201 and the service type field 202.

The load balancer 150 refers to the virtual MAC address 1702 of the virtual MAC header 181 to determine whether or not “Set” is set in the control field 205 (Step S1705).

When it is determined that “Set” is set in the control field 205, the load balancer 150 updates the distribution management table 424 (Step S1706), and ends the processing. Specifically, the following processing is executed.

The load balancer 150 adds new column information to the VM information 1005 of the entry retrieved in Step S1704. Further, the load balancer 150 stores the value set in the VM number field 204 in the VM number 1011 of the added column information, and stores the value set in the weight information field 203 in the weight information 1012.

When it is determined that “Set” is not set in the control field 205, in other words, when it is determined that “Del” is set in the control field 205, the load balancer 150 updates the distribution management table 424 (Step S1707), and ends the processing. Specifically, the following processing is executed.

The load balancer 150 refers to the virtual MAC header 181 of the received packet to acquire values set in the client number field 201, the service type field 202, and the VM number field 204. The load balancer 150 refers to the distribution management table 424 to search for an entry having values matching the values set in the client number field 201 and the service type field 202.

Further, the load balancer 150 refers to the VM information 1005 of the retrieved entry to search for column information whose VM number 1011 matches the acquired value of the VM number field 204. The load balancer 150 deletes the retrieved column information.

When it is determined that the received packet is not the ARP packet transmitted over the service network, the load balancer 150 assumes that a data packet is received and executes the following processing.

First, the load balancer 150 determines whether or not the received packet is a packet transmitted over the client network (Step S1751).

Specifically, the load balancer 150 determines whether or not the virtual MAC header 181 is added to the received packet. When the virtual MAC header 181 is not added to the received packet, it is determined that the received packet is the packet transmitted over the client network.

When it is determined that the received packet is the packet transmitted over the client network, the load balancer 150 acquires the source IP address and the VLAN number from the packet (Step S1752).

Specifically, the load balancer 150 analyzes the MAC header 172 of the received packet to acquire the source IP address and the VLAN number.

The load balancer 150 searches the distribution management table 424 for an entry having values matching those of the acquired source IP address and VLAN number (Step S1753).

Specifically, the load balancer 150 searches for the entry whose source IP address 1001 and VLAN number 1002 match the acquired source IP address and VLAN number.

The load balancer 150 determines whether or not there are a plurality of pieces of information on the VM 120 in the VM information 1005 of the retrieved entry (Step S1754).

Specifically, the load balancer 150 determines whether or not the VM information 1005 of the retrieved entry includes a plurality of pieces of column information on the VM 120. When the VM information 1005 includes a plurality of pieces of column information on the VM 120, it is determined that there are a plurality of pieces of information on the VM 120 in the VM information 1005 of the retrieved entry.

When it is determined that there is only one piece of column information on the VM 120 in the VM information 1005 of the retrieved entry, the load balancer 150 sets the VM number at the transfer destination to “1” (Step S1758), and the processing proceeds to Step S1756.

When it is determined that there are a plurality of pieces of information on the VM 120 in the VM information 1005 of the retrieved entry, the load balancer 150 acquires from the VM information 1005 the weight information 1012 of every VM 120, and based on the acquired weight information 1012, determines the VM 120 to which the received packet is to be transferred (Step S1755).

For example, based on the acquired weight information 1012, the load balancer 150 calculates allocation of the packets to be transferred to each VM 120, and based on the calculated allocation of the packets and an old transfer history, determines the VM 120 to which the received packet is to be transferred. It should be noted that this invention is not limited to the above-mentioned determination method for the VM 120, and another method may be used.

The load balancer 150 generates the virtual MAC header 181 (Step S1756). Specifically, the following processing is executed.

The load balancer 150 sets its MAC address as the load balancer MAC address 1701 of the virtual MAC header 181.

Further, the load balancer 150 acquires the client number 1003 and the service number 1004 from the entry retrieved in Step S1753. Then, the load balancer 150 acquires from the VM information 1005 of the entry the VM number 1011 and the weight information 1012 of the column information corresponding to the VM 120 which is determined as the transfer destination of the packet.

The load balancer 150 generates the virtual MAC address 123 based on the acquired client number 1003, service number 1004, VM number 1011, and weight information 1012, and sets the generated virtual MAC address 123 as the virtual MAC address 1702. It should be noted that “Set” is stored in the control field 205.

For example, when the transfer destination of the received packet is the VM 120-3, the virtual MAC address such as the one illustrated in FIG. 13 is generated.

The virtual MAC header 181 is generated as described above.

Next, the load balancer 150 encapsulates the received packet into the Ethernet packet in service network 180, and transmits the encapsulated packet (Step S1757). Thereafter, the load balancer 150 ends the processing.

Specifically, the load balancer 150 adds the generated virtual MAC header 181 to the received packet to encapsulate the packet into the Ethernet packet in service network 180.

The L2 switch 140 acquires the destination MAC address from the packet transmitted from the load balancer 150, and refers to the MAC table 1500 based on the acquired destination MAC address. The L2 switch 140 recognizes from the result of reference that the transmission destination of the received packet is the VM 120-3 which is coupled via the port YY. The packet transmitted from the port YY of the L2 switch 140 is received by the virtualization software 130-2 of the server 110-2, and is then transferred to the VM 120-3.

When it is determined in Step S1751 that the received packet is not the packet transmitted over the client network, in other words, when it is determined that the received packet is the packet transmitted over the service network, the load balancer 150 deletes the virtual MAC header 181 of the received packet, and then transmits the packet to the client network (Step S1759).

According to the embodiment of this invention, when the VM 120 is automatically added or deleted depending on an increase or decrease of processing packets transmitted from the client computer 160, it is possible to notify the load balancer 150 of the virtual MAC address 123 including information for distributing the packets. With this, the load balancer 150 can immediately and flexibly distribute the packets transmitted from the client computer 160.

It should be noted that in this embodiment, such a configuration that the L2 switch 140 is used for transferring the packets in the service network is adopted, but this invention is not limited thereto. Even when an L3 switch is used as a device for transferring the packets in place of the L2 switch 140, the same effects can be obtained.

It should be noted that in this embodiment, the VM management computer 100 is implemented as one set of hardware, but this invention is not limited thereto, and the VM management computer 100 may be implemented as software. In this case, for example, one server 110 executes the software so that the same functions as those of the VM management computer 100 can be provided.

Embodiments of this invention have now been described. However, this invention is not limited to the embodiments described above, and it would be easy for those skilled in the art to modify, add, or convert elements of the embodiments described above within the scope of this invention. For instance, a system or an apparatus to which this invention is applied can have only a part of the configurations of the plurality of embodiments described above, or can include all components of the plurality of embodiments described above. This invention allows for substituting some elements of the configuration of one embodiment with elements of another embodiment, and allows for adding a part of the configuration of one embodiment to another embodiment.

The configurations, functions, processing modules, processing units, and the like described above may partially or entirely be implemented by hardware by, for example, designing in the form of an integrated circuit. Information such as programs, tables, and files for implementing the respective functions can be stored in a storage device such as a non-volatile semiconductor memory, a hard disk drive, or a solid state drive, or in a computer-readable, non-transitory data storage medium such as an IC card, an SD card, or a DVD.

What is claimed is:

1. A computer system, comprising:
a client computer;
a server for providing the client computer with at least one service, the server comprising a first processor, a first memory connected to the first processor, and a first network interface connected to the first processor;
a load balancer for transferring a packet transmitted from one of the client computer and the server, the load balancer comprising a second processor, a second memory connected to the second processor, and a second network interface connected to the second processor;
at least one virtual machine that operates on the server, the at least one virtual machine communicating to/from another virtual machine by transmitting a packet including a virtual MAC address to be assigned to the at least one virtual machine, at least one virtual machine for providing a service being allocated to the client computer; and
a management unit provided for each client computer, for monitoring a load of the at least one virtual machine, and instructing one of addition and deletion of the at least one virtual machine based on a monitoring result,
the management unit being configured to:
hold identification information on the client computer, identification information on the service to be provided to the client computer, and distribution information for distributing packets transmitted from the client computer;
specify the server to which a new virtual machine is to be added, when it is determined based on the monitoring result that it is necessary to add a virtual machine which provides the client computer with the service;
generate the virtual MAC address including the identification information on the client computer, the identification information on the service to be provided to the client computer, and the distribution information corresponding to the specified server; and
transmit a command to generate the virtual machine including the generated virtual MAC address to the specified server.

2. The computer system according to claim 1,
wherein the load balancer holds distribution management information to be used in transferring the packet transmitted from the client computer to the virtual machine,
wherein the distribution management information includes at least one entry obtained by associating network identification information in the client computer, the identification information on the client computer, the identification information on the service to be provided to the client computer, and the distribution information for each virtual machine allocated to the client computer with one another, and
wherein the load balancer is configured to:
acquire, when receiving the packet transmitted from the new virtual machine, an identifier of the client computer and an identifier of the service from the virtual MAC address included in the received packet;
retrieve an entry corresponding to the acquired identifier of the client computer and the acquired identifier of the service by referring to the distribution management information; and
reflect the distribution information included in the received packet on the retrieved entry.

3. The computer system according to claim 2, wherein the load balancer is configured to:
analyze, when receiving the packet from the client computer, the received packet to acquire network identification information in the client computer;
retrieve an entry corresponding to the acquired network identification information in the client computer by referring to the distribution management information;
determine the virtual machine to which the received packet is to be transferred by using the distribution information included in the retrieved entry;
generate a virtual MAC header including the virtual MAC address of the determined virtual machine and a MAC address of the load balancer;
add the generated virtual MAC header to the received packet; and
transfer the packet added with the virtual MAC header to the determined virtual machine.

4. The computer system according to claim 2, wherein the load balancer is configured to:
analyze, when receiving a packet indicating deletion of the virtual machine from the virtual machine, the received packet to acquire identification information on the client computer and identification information on the service to be provided to the client computer;
retrieve an entry corresponding to the acquired identification information on the client computer and the acquired identification information on the service to be provided to the client computer by referring to the distribution management information; and
delete the distribution information corresponding to the virtual machine to be deleted, from the retrieved entry.

5. The computer system according to claim 3, wherein the load balancer is configured to:
analyze, when receiving a packet indicating deletion of the virtual machine from the virtual machine, the received packet to acquire identification information on the client computer and identification information on the service to be provided to the client computer;
retrieve an entry corresponding to the acquired identification information on the client computer and the acquired identification information on the service to be provided to the client computer by referring to the distribution management information; and
delete the distribution information corresponding to the virtual machine to be deleted, from the retrieved entry.

6. A packet transfer method for use in a computer system,
the computer system comprising:
a client computer;
a server for providing the client computer with at least one service, the server comprising a first processor, a first memory connected to the first processor, and a first network interface connected to the first processor;
a load balancer for transferring a packet transmitted from one of the client computer and the server, the load balancer comprising a second processor, a second memory connected to the second processor, and a second network interface connected to the second processor;
at least one virtual machine that operates on the server, the at least one virtual machine communicating to/from another virtual machine by transmitting a packet including a virtual MAC address to be assigned to the at least one virtual machine, at least one virtual machine for providing a service being allocated to the client computer; and
a management unit provided for each client computer, for monitoring a load of the at least one virtual machine, and instructing one of addition and deletion of the at least one virtual machine based on a monitoring result,
the management unit holding identification information on the client computer, identification information on the service to be provided to the client computer, and distribution information for distributing packets transmitted from the client computer,
the packet transfer method comprising:
specifying, by the management unit, the server to which a new virtual machine is to be added, when it is determined based on the monitoring result that it is necessary to add a virtual machine which provides the client computer with the service;
generating, by the management unit, the virtual MAC address including the identification information on the client computer, the identification information on the service to be provided to the client computer, and the distribution information corresponding to the specified server; and
transmitting, by the management unit, a command to generate the virtual machine including the generated virtual MAC address to the specified server.

7. The packet transfer method according to claim 6,
wherein the load balancer holds distribution management information to be used in transferring the packet transmitted from the client computer to the virtual machine,
wherein the distribution management information includes at least one entry obtained by associating network identification information in the client computer, the identification information on the client computer, the identification information on the service to be provided to the client computer, and the distribution information for each virtual machine allocated to the client computer with one another, and
wherein the packet transfer method further comprises:
acquiring, by the load balancer, when receiving the packet transmitted from the new virtual machine, an identifier of the client computer and an identifier of the service from the virtual MAC address included in the received packet;
retrieving, by the load balancer, an entry corresponding to the acquired identifier of the client computer and the acquired identifier of the service by referring to the distribution management information; and
reflecting, by the load balancer, the distribution information included in the received packet on the retrieved entry.

8. The packet transfer method according to claim 7, further comprising:
analyzing, by the load balancer, when receiving the packet from the client computer, the received packet to acquire network identification information in the client computer;
retrieving, by the load balancer, an entry corresponding to the acquired network identification information in the client computer by referring to the distribution management information;
determining, by the load balancer, the virtual machine to which the received packet is to be transferred by using the distribution information included in the retrieved entry;
generating, by the load balancer, a virtual MAC header including the virtual MAC address of the determined virtual machine and a MAC address of the load balancer;
adding, by the load balancer, the generated virtual MAC header to the received packet; and
transferring, by the load balancer, the packet added with the virtual MAC header to the determined virtual machine.

9. The packet transfer method according to claim 7 further comprising:
analyzing, by the load balancer, when receiving a packet indicating deletion of the virtual machine from the virtual machine, the received packet to acquire identification information on the client computer and identification information on the service to be provided to the client computer;
retrieving, by the load balancer, an entry corresponding to the acquired identification information on the client computer and the acquired identification information on the service to be provided to the client computer by referring to the distribution management information; and
deleting, by the load balancer, the distribution information corresponding to the virtual machine to be deleted, from the retrieved entry.

10. The packet transfer method according to claim 8, further comprising:
analyzing, by the load balancer, when receiving a packet indicating deletion of the virtual machine from the virtual machine, the received packet to acquire identification information on the client computer and identification information on the service to be provided to the client computer;
retrieving, by the load balancer, an entry corresponding to the acquired identification information on the client computer and the acquired identification information on the service to be provided to the client computer by referring to the distribution management information; and
deleting, by the load balancer, the distribution information corresponding to the virtual machine to be deleted, from the retrieved entry.
